(19) United States
(12) Patent Application Publication
(10) Pub. No.: US 2009/0029172 A1
(43) Pub. Date: Jan. 29, 2009

(54) THERMOPLASTIC RESIN COMPOSITION HAVING ABILITY TO ABSORB LIGHT WITH WAVELENGTH OF 420 NM AND MOLDED BODY THEREOF

(75) Inventor: Toshio Isozaki, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu Kosan Co., Ltd., Chiyoda-ku, Tokyo (JP)

(21) Appl. No.: 11/815,584

(22) PCT Filed: Jan. 17, 2006
(86) PCT No.: PCT/JP2006/300477

§ 371 Date: Aug. 6, 2007

(30) Foreign Application Priority Data
Feb. 17, 2005 (JP) 2005-040985

(51) Int. Cl. B32B 27/08; F21V 9/06

(52) U.S. Cl. 428/412; 252/589

(57) ABSTRACT

The present invention provides a thermoplastic resin composition comprising: (A) 100 parts by mass of a transparent thermoplastic resin; (B) 0.1 to 2.0 parts by mass of an ultraviolet absorber having an absorption band in the range at least of 340 to 410 nm, when determined in a chloroform solution; and (C) 0.005 to 0.25 parts by mass of an iron oxide fine particle having a mean primary particle diameter of 10 to 80 nm, and a molded article of the same. The thermoplastic resin composition of the present invention has excellent transparency, and shuts off light of 420 nm in wavelength. It can be widely used in the fields of optical, electric and electronic appliances, medical materials and others, and, for example, if it is formed for use in sunglasses and other articles, noticeable effect of eyeball protection can be expected.

### TECHNICAL FIELD

The present invention relates to a transparent thermoplastic resin composition capable of blocking light having a particular wavelength and to a molded article of the same, more specifically, to a transparent thermoplastic resin composition that is utilized in the fields of optical, electric and electronic appliances and medical materials etc. and has the ability to absorb light of 420 nm in wavelength, and to a molded article of the same.

### BACKGROUND ART

Light of 420 nm in wavelength is the most harmful ultraviolet ray (hereinafter referred to as UV) in daily life and also a major cause of cataract, which is an eye disease. The eyeballs after being operated need to be protected from such light. It is therefore required to effectively block it. The advent of a material capable of shutting off especially light of 420 nm in wavelength is desired strongly.

However, among known UV absorbers, there are almost no transparent resin compositions capable of absorbing light in a wavelength band of 400 nm or higher. The transmission coefficient of some metal oxides such as TiO₂ in a wavelength band of 400 nm or higher can be controlled, but to ensure their light-blocking properties sufficiently, their transparencies are sacrificed. Therefore, they cannot be used for applications in which their transparencies are needed. Moreover, some fluorescent whitening agents have absorption bands in the wavelength range of 400 nm or higher, but their performances deteriorate over time and molded articles thereof are not suitable for practical use.

In general, polycarbonate resins have excellent impact and heat resistances, and are widely used in various fields. However, the resins are somewhat problematic in terms of weathering resistance: undesired yellowish discoloration and other problems may occur when they are irradiated not only with normal solar source but also with light from high pressure mercury vapor lamps and metal halide lamps.

Therefore, conventionally resin compositions prepared by adding various photostabilizers singly or in combination to polycarbonate resins have been used, and similar resin compositions are proposed.

For example, a polycarbonate resin composition prepared by adding an ultraviolet absorber comprising a benzotriazole compound and a fluorescent whitening agent selected from coumarin compounds and naphthalimide compounds to a polycarbonate resin is proposed (Patent document 1). Moreover, a polycarbonate resin composition prepared by adding an ultraviolet absorber comprising a triazine compound and a fluorescent whitening agent selected from coumarin compounds and naphthalimide compounds to a polycarbonate resin is also proposed (Patent document 2).

However, these proposed polycarbonate resin compositions still cannot be said to have sufficient weathering resistance, nor can shut off light of 420 nm in wavelength.

Moreover, demand for a thermoplastic resin composition having both transparency and weathering resistance has been increasing in recent years. An improvement in weathering resistance is intended by adding a fine powder of titanium oxide (TiO₂) or zinc oxide (ZnO) (Patent documents 3 and 4), but sufficient transparency has not been obtained. A film whose transparency is ensured by adding a fine powder of zinc oxide is proposed (Patent document 5). Moreover, a thermoplastic resin composition containing an ultraviolet absorber and a fine powder of titanium oxide or zinc oxide in a resin composition such as polycarbonate is proposed as a thermoplastic resin composition having both transparency and weathering resistance (Patent document 6).

As mentioned above, resin compositions comprising an ultraviolet absorber and a thermoplastic resin are already known, but no transparent resin composition which can effectively absorb and block light in the boundary region of the visible light region and the ultraviolet light region is known. Transparent resin compositions which can effectively absorb and block light in the boundary region of the visible light region and ultraviolet light region are greatly expected, especially for the application of sunglasses. If a transparent material which can block light of 420 nm in wavelength is developed, weight reduction in sunglasses is achieved, and an increase in the number of people who use such glasses for preventing cataract is expected. Under such background, development of a material which shuts off light of especially 420 nm in wavelength is strongly desired.

[Patent document 1] Japanese Patent Application Publication No. H07-196904

[Patent document 2] Japanese Patent Application Publication No. H10-176103

[Patent document 3] Japanese Patent Application Publication No. H06-238829

[Patent document 4] Japanese Patent Application Publication No. H07-173303

[Patent document 5] Japanese Patent Application Publication No. 2000-309100

[Patent document 6] Japanese Patent Application Publication No. 2004-331679

### DISCLOSURE OF THE INVENTION

The present invention was made considering the circumstances described above. An object of the present invention is to provide a thermoplastic resin composition which has excellent transparency and the ability to shut off the light of 420 nm in wavelength and a molded article of the same.

The inventors of the present invention conducted extensive research to achieve the above object. As a result, they found that a thermoplastic resin composition which has excellent transparency and the ability to shut off the light of 420 nm in wavelength and a molded article of the same can be obtained by adding a specific fine particle of iron oxide and an ultraviolet absorber and to a transparent thermoplastic resin such as polycarbonate. The present invention was accomplished on a basis of such findings.

That is the present invention provides the following thermoplastic resin composition and molded article of the same.

(1) A thermoplastic resin composition comprising: (A) 100 parts by mass of a transparent thermoplastic resin; (B) 0.1 to 2.0 parts by mass of an ultraviolet absorber having an absorption band in the range at least of 340 to 410 nm, when determined in a chloroform solution; and (C) 0.005 to 0.25 parts by mass of an iron oxide fine particle having a mean primary particle diameter of 10 to 80 nm.
(2) The thermoplastic resin composition as defined in (1) wherein the transparent thermoplastic resin of the component (A) is a polycarbonate resin.
(3) The thermoplastic resin composition as defined in (1) or (2) wherein the ultraviolet absorber of the component (B) is at least one compound selected from benzotriazole compounds and benzoate compounds.
(4) The thermoplastic resin composition as defined in any one of (1) to (3), wherein the iron oxide fine particle of the component (C) is dispersed in a functional group-containing silicone oil.
(5) The thermoplastic resin composition as defined in any one of (1) to (4) wherein a transmission coefficient of light of 410 nm in wavelength is 0.1% or lower, and a transmission coefficient of light of 420 nm in wavelength is 10% or lower and a haze value is 3% or lower in a molded article having a thickness of 2 mm.
(6) A molded article formed by molding any one of thermoplastic resin compositions as defined in (1) to (5), wherein the molded article blocks light of 420 nm in wavelength and has transparency.
(7) The molded article as defined in (6), wherein the molded article is formed by injection molding of a thermoplastic resin compositions as defined in any one of (1) to (5).
(8) The molded article of a laminated structure at least containing a molded article as defined in (6) or (7).
(9) The molded article as defined in (8), wherein the molded article is formed by co-extruding a thermoplastic resin compositions as defined in any one of (1) to (5) and another transparent thermoplastic resin.
(10) The molded article as defined in (8), wherein the molded article is formed by extruding a thermoplastic resin compositions as defined in any one of (1) to (5) and another transparent thermoplastic resin separately to form a molded article, and bonding the obtained individual molded articles together.
(11) The molded article as defined in any one of (6) to (10), for use in applications of sunglass lenses, goggle lenses, photoresists, lighting apparatus covers or housings for transparent office automation equipment, and electric or electronic appliances.
(12) The molded article as defined in any one of (6) to (10), for use in applications of intraocular lenses and medial materials.

### BEST MODE FOR CARRYING OUT THE INVENTION

Examples of the transparent thermoplastic resin of the component (A) in the present invention include polycarbonate resins, polyolefin resins such as polyethylene, polypropylene and polybutylene, polyvinyl chloride resins, polyvinylidene chloride resins, polyvinyl acetate resins, polyvinyl alcohol resins, chlorinated polyethylene resins, ethylene-α-olefin copolymers, propylene-α-olefin copolymers, ethylene-vinyl chloride copolymers, ethylene-vinyl acetate copolymers, ethylene tetrafluoride-ethylene copolymers, ethylene tetrafluoride-propylene hexafluoride copolymers, vinyl polyfluoride resins, polyvinylidene difluoride resins, transparent polyamide resins, polyethylene terephthalate resins, polyethylene naphthalate resins and the like. These may be used singly or in combination of two or more kinds. In the present invention, polycarbonate resins are preferred in terms of obtaining a molded article having good transparency.

As the above-mentioned polycarbonate resins, their chemical structures and production methods are not particularly limited and various substances can be used. For example, aromatic polycarbonate resins produced by a reaction between a divalent phenol and a carbonate precursor can be suitably used.

Various substances can be used as the above-mentioned divalent phenol. Suitable examples include 2,2-bis(4-hydroxyphenyl)propane, bis(4-hydroxyphenyl)methane, 1,1-bis(4-hydroxyphenyl)ethane, 2,2-bis(4-hydroxy-3,5-dimethylphenyl)propane, 4,4′-dihydroxydiphenyl, 1,1-bis(4-hydroxyphenyl)cyclohexane, bis(4-hydroxyphenyl)ether, bis(4-hydroxyphenyl)sulfide, bis(4-hydroxyphenyl)sulfone, bis(4-hydroxyphenyl)sulfoxide, bis(4-hydroxyphenyl)ketone, hydroquinone, resorcin, catechol and the like. Among these divalent phenols, bis(hydroxyphenyl)alkane, in particular 2,2-bis(4-hydroxyphenyl)propane [bisphenol A] is preferred. These divalent phenols may be used singly or in combination of two or more kinds.

Moreover, carbonate precursors usable for a reaction with a divalent phenol are carbonyl halides, carbonyl esters, or haloformates and the like. More specifically, phosgene, dihaloformates of divalent phenols, diphenyl carbonates, dimethyl carbonates and diethyl carbonates can be used.

The chemical structure of this polycarbonate resin can be such that its molecular chain has a linear structure, a cyclic structure or a branched structure. Among these, suitable examples of polycarbonate resins having a branched structure include those produced by using, as a branching agent, 1,1,1-tris(4-hydroxyphenyl)ethane, α,α′,α″-tris(4-hydroxyphenyl)-1,3,5-triisopropylbenzene, phloroglucin, trimellitic acid, isatinbis(o-cresol) and the like. Moreover, as this polycarbonate resin, polyester-carbonate resins produced by using bifunctional carboxylic acids such as terephthalic acid or their ester precursors such as ester forming derivatives can be also used. Furthermore, mixtures of these polycarbonate resins having various chemical structures can be also used.

The viscosity average molecular weight of these polycarbonate resins is normally 10,000 to 50,000, preferably 13,000 to 35,000, more preferably 15,000 to 25,000. This viscosity average molecular weight (Mv) is a value obtained by determining the viscosity of a methylene chloride solution at 20° C. by using an Ubbelohde viscometer, determining an intrinsic viscosity [η] from this measurement and calculated by the equation of [η]=1.23×10⁻⁵ Mv.^{0.83}

For such adjustment of the molecular weight of a polycarbonate resin, phenol, p-tert-butylphenol, p-dodecylphenol, p-tert-octylphenol, p-cumylphenol and the like are used.

As this polycarbonate resin, polycarbonate-polyorganosiloxane copolymers can be further used. This copolymer can be prepared by, for example, dissolving polycarbonate oligomer and polyorganosiloxane having a terminal reactive group in a solvent such as methylene chloride, adding an aqueous solution of divalent phenol in sodium hydroxide to this solution, and causing an interface polycondensation reaction by using a catalyst such as triethylamine. As a polyorganosiloxane structure portion in this case, that having polydimethyl siloxane structure, polydiethyl siloxane structure, polymethylphenyl siloxane structure, polydiphenyl siloxane structure is suitably used.

Moreover, this polycarbonate-polyorganosiloxane copolymer used is suitably such that the degree of polymerization of the polycarbonate portion is 3 to 100 and the degree of polymerization of the polyorganosiloxane portion is approximately 2 to 500. Moreover, the amount of the polyorganosiloxane portion contained in this polycarbonate-polyorganosiloxane copolymer is suitably 0.5 to 30% by mass, preferably 0.5 to 20% by mass. Furthermore, the viscosity average molecular weight of this polycarbonate-polyorganosiloxane copolymer is 10,000 to 50,000, preferably 13,000 to 35,000, and more preferably 15,000 to 25,000.

The ultraviolet absorber of the component (B) used in the present invention has an absorption band in the range of at least 340 to 410 nm, when determined in a chloroform solution. The phrase “to have an absorption band in the range at least of 340 to 410 nm” means that an absorbance determined by a spectrophotometer (calculated from the strength of a transmission light relative to incident light) falls within the range of the absorption band. Examples of such ultraviolet absorbers include benzophenone-based compounds, benzotriazole-based compounds, benzoate compounds, cyanoacrylate-based compounds and the like, and in particular benzotriazole-based compounds or benzoate compounds are preferred. The amount added is 0.1 to 2.0 parts by mass, preferably 0.2 to 1.0 part by mass based on 100 parts by mass of the thermoplastic resin such as polycarbonate. By adding 0.1 to 2.0 parts by mass of an ultraviolet absorber having an absorption band in the range at least of 340 to 410 nm, a resin composition having a good absorptivity for the light of 420 nm in wavelength or lower can be obtained.

Specific examples of benzophenone-based compounds used as the above-mentioned ultraviolet absorber include 2-hydroxy-4-n-octoxybenzophenone, 2-hydroxy-4-methoxy-benzophenone, 2-hydroxy-4-ethoxy-benzophenone and the like.

Moreover, specific examples of the above-mentioned benzotriazole-based compound include 2-(2′-hydroxy-5′-tert-octylphenyl)benzotriazole, 2-(2′-hydroxy-3′,5′-di-tert-amylphenyl)benzotriazole, 2-(2′-hydroxy-5′-tert-butylphenyl)benzotriazole, 2-(2′-hydroxy-3′,5′-di-tert-butylphenyl)benzotriazole, 2-[2′-hydroxy-3′,5′-bis(α,α-dimethylbenzyl)phenyl]-2H-benzotriazole, 2,2′-methylene-bis[4-methyl-6-(benzotriazole-2-yl)phenol] and the like.

Specific example of the above-mentioned benzoate compound include diethylamino hydroxybenzoyl hexyl benzoate, methylethylamino hydroxybenzoyl hexyl benzoate, dimethylamino hydroxybenzoyl octyl benzoate, ethylpropylamino hydroxybenzoyl hexyl benzoate, dipropylamino hydroxybenzoyl hexyl benzoate and the like.

Specific examples of the above-mentioned cyanoacrylate-based compounds include 2-ethyl-2-cyano-3,3-diphenyl acrylate, 2-ethylhexyl-2-cyano-3,3-diphenyl acrylate, 1,3-bis-[2′-cyano-3,3′-diphenylacryloyloxy]-2,2-bis-[(2-cyano-3′,3′-diphenylacryloyl)oxy]methylpropane and the like.

In the present invention, a compound obtained by graft-polymerizing an ultraviolet-absorbing unit on an acrylic polymer can be also used as the ultraviolet absorber of the component (B). This compound has a structure in which an ultraviolet-absorbing unit having an ultraviolet absorptivity is introduced into a polymer chain of the acrylic polymer by graft polymerization (hereafter referred to as “high-molecular ultraviolet absorber”). Examples of acrylic monomer constituting this acrylic polymer include acrylic acid, methacrylic acid, alkyl acrylate esters, alkyl methacrylate esters, acrylamide, methacrylamide, copolymerized polymers of these acrylic monomers and copolymerizable vinyl compounds having a double bond and the like. Examples of this copolymerizable vinyl compounds include alkyl vinyl ethers such as methyl vinyl ether and ethyl vinyl ether; vinyl acetate, alkyl vinyl esters such as ethylvinyl ester and 2-ethylhexylvinyl ester; styrene, maleic anhydride and the like. The number average molecular weights of these acrylic polymers are 20,000 to 200,000, and preferably 50,000 to 200,000.

An ultraviolet-absorbing unit introduced into this acrylic polymer may be any compound that has an ultraviolet absorptivity. Examples include the aforementioned benzophenone-based compounds, benzotriazole-based compounds, cyanoacrylate-based compounds, benzoate compounds and the like. These compounds are introduced into polymer chains of acrylic polymers by graft polymerization. In this case, the amount of the ultraviolet-absorbing unit introduced into the acrylic polymer is 40 to 90% by mass, preferably 50 to 80% by mass of the total mass of the ultraviolet absorber.

Preferable high-molecular ultraviolet absorbers are those in which the ultraviolet-absorbing unit is a benzotriazole compound or a benzoate compound and the number average molecular weight of the acrylic polymer is 50,000 to 200,000. The high-molecular ultraviolet absorbers may be used singly or in combination of two or more kinds, and can be also used in combination with the aforementioned ultraviolet absorbers.

The mean primary particle diameter of the iron oxide fine particle of the component (C) in the present invention is 10 to 80 nm, preferably 15 to 60 nm, and more preferably 20 to 50 nm. Absorption and shielding of light with a particular wavelength is enabled by making this mean primary particle diameter 10 nm or more, while desired transparency can be obtained by making this mean primary particle diameter 80 nm or less.

Iron oxide fine particle used in the present invention is preferably processed with surface treatment. Examples of surface treatment agents include one or more members selected from aluminium oxide (Al₂O₃), zirconium oxide (ZrO₂), stearic acid and the like.

The above-mentioned iron oxide fine particle is preferably used as a dispersion in a carrier medium. Examples of the carrier medium include functional group-containing silicone compounds, polyalkylene glycol, polyolefin wax, carboxylate esters and the like. Among these, functional group-containing silicone compounds are preferred. Examples of the functional group include alkoxy group such as methoxy group and ethoxy group, hydrogen atom, hydroxyl group, epoxy group, vinyl group, for example. A preferable functional group-containing silicone compound is organopolysiloxane having one or more of these functional groups. Specific examples include silicone oils such as triphenyl methoxysilane, diphenylmethoxysilane, phenyltrimethoxysilane and methylphenylpolysiloxane which has a terminal hydroxyl group. These substances may be used singly or in combination of two or more kinds.

The amount of the iron oxide fine particle in the carrier medium is preferably 10 to 70% by mass, and more preferably 10 to 50% by mass.

The amount of the above-mentioned iron oxide fine particle added is 0.005 to 0.25 parts by mass, preferably 0.02 to 0.15 parts by mass, and more preferably 0.05 to 0.1 parts by mass, based on 100 parts by mass of the thermoplastic resin. This amount added is calculated as the iron oxide fine particle, and, for example, when the amount of the iron oxide fine particle in the carrier medium is 50% by mass, the amount of a mixture of this fine particle and carrier medium added needs to be 0.01 to 0.5 parts by mass based on 100 parts by mass of the thermoplastic resin.

If necessary, a stabilizer (antioxidant, dispersing agent, etc.), mold releasing agent, coloring agent (dye, pigment) and other additives can be added to the thermoplastic resin composition of the present invention in a range which does not adversely affect the effect of the present invention. Examples of antioxidants include phenol-based antioxidants such as pentaerythrityl-tetrakis[3-(3,5-di-t-butyl-4-hydroxyphenyl)propionate]; phosphorus-based antioxidants such as phosphite esters and tris(2,4-di-t-butylphenyl)phosphite; and sulfur-based antioxidants such as dilauryl-3,3′-thiodipropionate. Examples of dispersing agents include magnesium stearate and the like. Examples of mold releasing agents include monoglycerin stearate, polyethylene tetrastearate and the like. The antioxidant and mold releasing agent may contain a radical scavenger and an acid neutralizer. As a coloring agent, a generally used pigment or the like is used. The amount of these additives added is preferably 1 part by mass or less based on 100 parts by mass of the thermoplastic resin composition.

Regarding the method of producing the thermoplastic resin composition of the present invention, if necessary, the above additives may be added to the above components (A) to (C) in an amount suitable for required characteristics of a molded article and kneaded. Blenders and kneaders used herein are those normally used. For example, a ribbon blender, drum tumbler and the like can be used to carry out pre-mix, and a Henschel mixer, Banbury mixer, single screw extruder, twin screw extruder, multiple screw extruder, Ko-kneader or the like may be used. The heating temperature in kneading is normally selected from the range from 240 to 300° C. suitably. For this fusion kneading molding, an extrusion molder, in particular a vented extrusion molder is preferably used. The components other than the thermoplastic resin contained can be fused and kneaded with the thermoplastic resin in advance, that is, can be added as a master batch.

The thermoplastic resin composition of the present invention can be used as a raw material in the form of a kneaded product obtained by the above-mentioned fusion kneading molding or pellets to produce various kinds of molded articles by injection molding, injection-compression molding, extrusion molding, blow molding, press molding, foam molding or other methods. In this case, especially preferable is the method of fusing and kneading the components mentioned above to produce a pelletized molding raw material, and then producing injection molded articles by injection molding or injection-compression molding with these pellets. Moreover, employing the gas injection molding as this injection molding can give a molded article which has no sink mark but has excellent appearance and reduced weight.

By forming the thermoplastic resin composition of the present invention, a molded article capable of blocking light of 420 nm in wavelength and having transparency, for example, a molded article in which a transmission coefficient of light of 410 nm in wavelength is 0.1% or lower, and a transmission coefficient of light of 420 nm in wavelength is 10% or lower, and a haze value is 3% or lower in a molded article having a thickness of 2 mm can be obtained.

Moreover, a molded article with a laminated structure can be obtained by co-extruding the thermoplastic resin composition of the present invention and another transparent thermoplastic resin. A molded article with a laminated structure can be also obtained by extruding the thermoplastic resin composition of the present invention and another transparent thermoplastic resin separately to form molded articles, and bonding the obtained separate molded articles together.

A molded article using the thermoplastic resin composition obtained according to the present invention can be widely used in the fields of optical, electric and electronic appliances, medical materials, for example, for sunglass lenses, goggle lenses, photoresists, lighting apparatus covers, transparent office automation equipment, housings for electric or electronic appliances, intraocular lenses and various medical materials.

### EXAMPLES

The present invention is now described in more details with reference to Examples, but the present invention is not limited to these Examples.

Evaluation of performance was carried out by the measurement methods described below.

Initial haze value (%); Measurement was conducted by using a full-automatic direct-reading haze computer HGM-2DP (light source C) manufactured by Suga Test Instruments Co., Ltd. according to JIS K7105.
Spectral transmission factor: A 10-μg/ml chloroform solution was prepared. A spectral transmission factor of 350 to 700 nm was determined by using a recording spectrophotometer UV-2400PCS manufactured by Shimadzu Corporation.

### Examples 1 to 7, Comparative Examples 1 to 8

(B) an ultraviolet absorber and (C) a metal fine particle were added to 100 parts by mass of (A) a polycarbonate resin (PC-A2200 manufactured by Idemitsu Kosan Co., Ltd.) in the formulation amounts shown in Table 1, and the mixtures were fused and kneaded by a 50-mm single shaft extruder (NVC50) at 280° C. and pelletized. Injection molding was performed by a 440KN injection molding machine (IS45PV manufactured by Toshiba Machine Co., Ltd.) using pellets to obtain test pieces (30 mm×40 mm×2 mm). The evaluation results of the optical properties of the test pieces determined in the manner described above are shown in Table 1.

(B) the ultraviolet absorber and (C) the metal fine particle used in Table 1 are as follows:

B-1; 2-(3-tert-butyl-5-methyl-2-hydroxyphenyl)-5-chlorobenzotriazole (Tin326 manufactured by Ciba Specialty Chemicals K.K., absorption band: 260 to 410 nm)
B-2; diethylamino hydroxybenzoyl hexyl benzoate (Yupinal A, Plus manufactured by BASF Japan Ltd., absorption band: 250 to 410 nm)
C-1; Fe₂O₃(FRO-3 manufactured by Sakai Chemical Industry Co., Ltd.)

Mean primary particle diameter: 30 nm, and metal particles subject to surface treatment with aluminum oxide and stearic acid

C-1-1; Fe₂O₃/silicone compound described below =mass ratio: 50/50

Fe₂O₃ (FRO-3 manufactured by Sakai Chemical Industry Co., Ltd.)

Silicone compound (AZ6207 manufactured by Nippon Unicar Co., Ltd.)

C-2; TiO₂(TTO-55(B) manufactured by Ishihara Sangyo Kaisha, Ltd.)
C-2-1; TiO₂/silicone compound mentioned above=mass ratio: 50/50

TABLE 1

| | Example 1 | Ex. 2 | Ex. 3 | Ex. 4 | Ex. 5 | Ex. 6 | Ex. 7 |
|---|---|---|---|---|---|---|---|
| (Amount added: part by mass/100 parts | | | | | | | |
| by mass of PC resin) | | | | | | | |
| B-1: UV absorber (Tin326) | 0.3 | 0.5 | 1.0 | | | | 0.5 |
| B-2: UV absorber (Yupinal A Plus) | | | | 0.3 | 0.5 | 1.0 | 0.5 |
| C-1: Fe₂O₃ microparticle | | | | | | | |
| C-1-1: Fe₂O₃/silicone compound = 50/50 | 0.1 | 0.05 | 0.01 | 0.1 | 0.05 | 0.01 | 0.01 |
| C-2: TiO₂ fine particle | | | | | | | |
| C-2-1: TiO₂/silicone compound = 50/50 | | | | | | | |
| (Evaluation of optical characteristics) | | | | | | | |
| Initial haze value (%) | 2.8 | 2.6 | 2.0 | 2.6 | 2.4 | 1.8 | 1.9 |
| Spectrum transmission factor at 400 nm (%) | <0.01 | <0.01 | <0.01 | <0.01 | <0.01 | <0.01 | <0.01 |
| Spectrum transmission factor at 410 nm (%) | <0.01 | <0.01 | <0.01 | <0.01 | <0.01 | <0.01 | <0.01 |
| Spectrum transmission factor at 420 nm (%) | 4.2 | 5.8 | 7.6 | 4.0 | 5.7 | 7.5 | 7.5 |

| | Comparative | Comp. | Comp. | Comp. | Comp. | Comp. | Comp. | Comp. |
|---|---|---|---|---|---|---|---|---|
| | Example. 1 | Ex. 2 | Ex. 3 | Ex. 4 | Ex. 5 | Ex. 6 | Ex. 7 | Ex. 8 |
| (Amount added: part by mass/100 parts | | | | | | | | |
| by mass of PC resin) | | | | | | | | |
| B-1: UV absorber (Tin326) | | | | | | 1.0 | | 1.2 |
| B-2: UV absorber (Yupinal A Plus) | | | | | | | 1.0 | |
| C-1: Fe₂O₃ microparticle | | | 0.005 | | | | | |
| C-1-1: Fe₂O₃/silicone compound = 50/50 | 0.01 | 0.6 | | | | | | 0.005 |
| C-2: TiO₂ fine particle | | | | 0.1 | | | | |
| C-2-1: TiO₂/silicone compound = 50/50 | | | | | 0.1 | | | |
| (Evaluation of optical characteristics) | | | | | | | | |
| Initial haze value (%) | 2.0 | 16.8 | 20.1 | 24.8 | 10.6 | 1.4 | 1.2 | 1.9 |
| Spectrum transmission factor at 400 nm (%) | <0.01 | <0.01 | <0.01 | <0.01 | <0.01 | <0.01 | <0.01 | <0.01 |
| Spectrum transmission factor at 410 nm (%) | 1.8 | <0.01 | 1.6 | <0.01 | <0.01 | <0.01 | <0.01 | <0.01 |
| Spectrum transmission factor at 420 nm (%) | 4.1 | <0.01 | 4.9 | <0.01 | <0.01 | 24.2 | 16.5 | 11.2 |

Table 1 reveals the followings:

(1) B-1 and B-2 in Examples 1 to 7 are both ultraviolet absorbers having an absorption band in the range of 340 to 410 nm, and 0.1 to 2.0 parts by mass of the ultraviolet absorber is contained based on 100 parts by mass of the transparent thermoplastic resin. Moreover, each Example contains 0.005 to 0.25 parts by mass of the iron oxide fine particle having a primary average particle diameter of 30 nm. Therefore, it is learned that the molded article of 2 mm thick and of thermoplastic resin composition of the present invention obtained has a transmission coefficient of 0.1% or lower for light of 410 nm in wavelength, a transmission coefficient of 10% or lower for light of 420 nm in wavelength, and a initial haze value of 3% or lower.
(2) When iron oxide fine particles and iron oxide/silicone compound dispersions and titanium oxide are used without using ultraviolet absorbers in the thermoplastic composition, the initial haze value is worsened (Comparative Examples 1 to 5).
(3) When the amount of the iron oxide fine particle is zero or too low even if an ultraviolet absorber is used, it is difficult to block light of 420 nm in wavelength (Comparative Examples 6 to 8).

### INDUSTRIAL APPLICABILITY

According to the present invention, a transparent thermoplastic resin composition which has excellent absorptivity of light of 420 nm in wavelength and a molded article of the same can be provided by adding a specific iron oxide fine particle and an ultraviolet absorber to a transparent thermoplastic resin such as polycarbonate. The thermoplastic resin composition of the present invention can be widely used in the fields of optical, electric or electronic appliances, medical materials and others, and, for example, if it is formed into sunglasses then noticeable eyeball protection effect can be expected.

1. A thermoplastic resin composition comprising: (A) 100 parts by mass of a transparent thermoplastic resin; (B) 0.1 to 2.0 parts by mass of an ultraviolet absorber having an absorption band in the range at least of 340 to 410 nm, when determined in a chloroform solution; and (C) 0.005 to 0.25 parts by mass of an iron oxide fine particle having a mean primary particle diameter of 10 to 80 nm.

2. The thermoplastic resin composition as defined in claim 1, wherein the transparent thermoplastic resin is a polycarbonate resin.

3. The thermoplastic resin composition as defined in claim 1, wherein the ultraviolet absorber is at least one compound selected from the group consisting of benzotriazole compounds and benzoate compounds.

4. The thermoplastic resin composition as defined in claim 1, wherein the iron oxide fine particle is dispersed in a functional group-containing silicone oil.

5. The thermoplastic resin composition as defined in claim 1, wherein a transmission coefficient of light of 410 nm in wavelength is 0.1% or lower, a transmission coefficient of light of 420 nm in wavelength is 10% or lower, and a haze value is 3% or lower in a molded article having a thickness of 2 mm.

6. A molded article formed by molding a thermoplastic resin composition as defined in claim 1, wherein the molded article blocks light of 420 nm in wavelength and has transparency.

7. The molded article as defined in claim 6, wherein the molded article is formed by injection molding.

8. A molded article of a laminated structure at least comprising the molded article as defined in claim 6.

9. A molded article of a laminated structure, wherein the molded article is formed by co-extruding a thermoplastic resin composition as defined in claim 1 and another transparent thermoplastic resin.

10. A molded article of a laminated structure, wherein the molded article is formed by extruding a thermoplastic resin composition as defined in claim 1 and another transparent thermoplastic resin separately to form molded articles, and bonding the obtained separate molded articles together.

11. The molded article as defined in claim 6, wherein the molded article is one selected from the group consisting of sunglass lenses, goggle lenses, photoresists, lighting apparatus covers, transparent office automation equipment, and housings of electric or electronic appliances.

12. The molded article as defined in claim 6, wherein the molded article is one selected from the group consisting of intraocular lenses and medical materials.
